(19) United States
(12) Patent Application Publication
(10) Pub. No.: US 2006/0069599 A1
(43) Pub. Date: Mar. 30, 2006

(54) Workflow tasks in a collaborative application

(75) Inventors: George F. Hatoun, Redmond, WA (US); Jon F. Matousek, Issaquah, WA (US); Rajesh Kamath, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/212,207

(22) Filed: Aug. 25, 2005

Related U.S. Application Data
(60) Provisional application No. 60/614,096, filed on Sep. 29, 2004.

(51) Int. Cl. G05B 19/418

(52) U.S. Cl. 705/8

(57) ABSTRACT

Workflows designed to take advantage of the capabilities of workflow-enabled application programs are disclosed. Examples of workflow-enabled application programs are word processing application programs and e-mail application programs. In response to determining that an incomplete workflow task exists, forms data is sent to a workflow-enabled application program. In response to the receipt of forms data, the workflow-enabled application program presents a workflow task form to the user of the workflow-enabled application program. Embodiments may determine whether a workflow task change or completion by a particular user at a particular time is authorized by the workflow. If a workflow task change or completion is not authorized the workflow rolls back the workflow task to a previous version of the task. Embodiments may determine if an incomplete workflow task is assigned to a group, and, if so assigned, function to prevent duplication of effort by participants in the group.

### CROSS-REFERENCE TO RELATED APPLICATION

Pursuant to 35 U.S.C. § 119, this application claims the benefit of the filing date of Provisional Patent Application No. 60/614,096, filed Sep. 29, 2004, titled WORKFLOW IN A COLLABORATIVE APPLICATION, the subject matter of which is also incorporated herein by reference.

### BACKGROUND

In the physical world, a task is a module of work to be performed, i.e., a work module, such as, for example, drafting and/or approving a set of engineering drawings, approving travel vouchers, etc. In computing systems that model systems that use work modules, such as but not limited to, business systems, a task is a software object that encapsulates a work module and provides functions, i.e., capabilities, for viewing and manipulating data associated with the work module. A task software object includes data such as, but not limited to, the name of the task, the person assigned to the task, the percentage of the task that has been completed, and the task due date. Among other capabilities, a task software object tracks work module progress, i.e., the progress of work encompassed by a work module. Work may be done by a human being, software running on a computing device, or both.

Using a task software object to track work module progress provides useful project management information. More and better project management information can be provided by tracking the progress of the work encompassed by related work modules, e.g., business process work modules, with a plurality of tasks organized according to relationships of the tasks. A plurality of tasks organized according to the relationships of the tasks is called a workflow. In effect, a workflow tracks how work flows through a business process. Thus, a task generated and managed by a workflow is a “workflow task.” For example, a workflow may be developed for the approval of documents employed in a business process, i.e., a document approval workflow. A document approval workflow may be used to track documents through an approval process as each participant in the approval process receives and approves documents. Thus, an example of a task in such a workflow is a document approval task. A workflow participant, i.e., participant, is assigned the document approval task. Most often, a participant is a human; however, a participant may be a software module running on a computer. The participant does the work required by the document approval task, e.g., review and approve one or more documents.

Workflow tasks can be improved. For example, in order to perform the activities required by a document approval task, the approving participant may require the use of two computer software applications, i.e., applications. One application is used to open and review the document and the other application is used to approve the document and communicate the approval to the workflow. There are disadvantages to using more than one application to review and approve a document. At best, participants are required to access two applications in order to approve a single document. At worst, documents are not approved because participants have difficulty finding an application to open the document, finding a workflow application, and/or finding the appropriate approval forms for the document in the workflow application.

Another way workflow tasks may be improved is to enable workflow tasks to be set back to a known, stable state, i.e., rolled back, in cases of improper or untimely attempts to complete a workflow task. For example, a task may have a specific time period in which a document is available for approval, i.e., the approval period. If a task is unable to use a workflow's ability to track the approval period and timely inform a participant when an approval period ends, the task cannot be rolled back in case of a belated attempt by a participant to approve a document. Likewise, if a task is unable to use a workflow's ability to track authorized approval of a participant, the task cannot be rolled back in case of an attempt by an unqualified participant to approve a document.

A third way workflow tasks may be improved is to enable workflow tasks to be assigned to groups of participants. Normally a workflow assigns a workflow task to single individual participants. If the assigned participant is not available to perform the workflow task, it may be difficult to find another available and qualified participant to perform the task. Regardless of difficulty, identifying and locating another available and qualified participant is time-consuming and, therefore, undesirable. In contrast, if a workflow task is assigned to a group of participants, a workflow can select an available participant to perform the task from a group of qualified participants. Assigning a workflow task to a group of participants also allows a participant in a group to “claim” a workflow task assigned to the workflow group and thereby prevent duplication of effort.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Improving and/or adding workflow capabilities to applications is described. One such capability is enabling the generation and presentation of all necessary participant forms without requiring that a participant access multiple applications. Another such capability is roll back in case of improper or untimely attempts at workflow task completion. A third such capability is assigning tasks to groups of participants and enabling participants in a group to claim tasks assigned to the group.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram showing how workflow-enabled applications interact with workflows and workflow tasks using the Windows SharePoint Services Workflow Object Model (WSS Workflow OM);

FIG. 2 is an exemplary class diagram showing the relationship of a Task class and a WorkflowTask class;

FIG. 3 is an exemplary user interface for viewing a list of tasks;

FIG. 4 is an exemplary user interface for viewing a subset of the list of tasks in FIG. 3;

FIG. 5 is an exemplary user interface for viewing the details of a task from the subset of tasks in FIG. 4;

FIG. 6 is an exemplary user interface for editing the details of the task shown in FIG. 5;

FIG. 7 is an exemplary document opened in an exemplary implementation of a workflow-enabled word processing application that displays an exemplary icon to access workflow tasks associated with the document;

FIGS. 8A-B is functional flow diagram showing how access to an exemplary workflow task is provided for an exemplary document in an exemplary workflow via an exemplary workflow-enabled word processing application;

FIG. 9 is an exemplary e-mail opened in an exemplary implementation of a workflow-enabled e-mail application that displays exemplary icons for workflow tasks; and

FIGS. 10A-B is functional flow diagram showing how access to an exemplary workflow task is provided for an exemplary document in an exemplary workflow via an exemplary workflow-enabled e-mail application.

### DETAILED DESCRIPTION

As noted above, a workflow task is a software object generated and managed by a workflow that encapsulates data about, and provides capabilities related to, the work modules of a workflow. Workflow tasks are generated and managed by workflows. Workflows are executed by a workflow engine. Workflow-enabled applications interact with a workflow engine to exchange data with workflows executed by the workflow engine. Workflow-enabled applications are applications that contain computer code that enables direct interaction with workflows allowing workflow-enabled applications to take advantage of a wider range of workflow capabilities. Contrarily, non-workflow-enabled applications indirectly interact or refer to workflows and are limited to using relatively few workflow capabilities. The operation of a workflow engine and the communication between the workflow engine and workflow-enabled applications is supported by a collaborative application, such as Microsoft® Windows® SharePoint, i.e., Windows® SharePoint, for example. Windows® SharePoint is a collaborative application program that provides services, i.e., Windows® SharePoint Services (WSS), that enable workflow engines to operate and communicate with applications such as workflow-enabled applications. WSS provides an application programming interface (API) that applications may use to communicate with WSS called Windows® SharePoint Services Workflow Object Model (WSS Workflow OM).

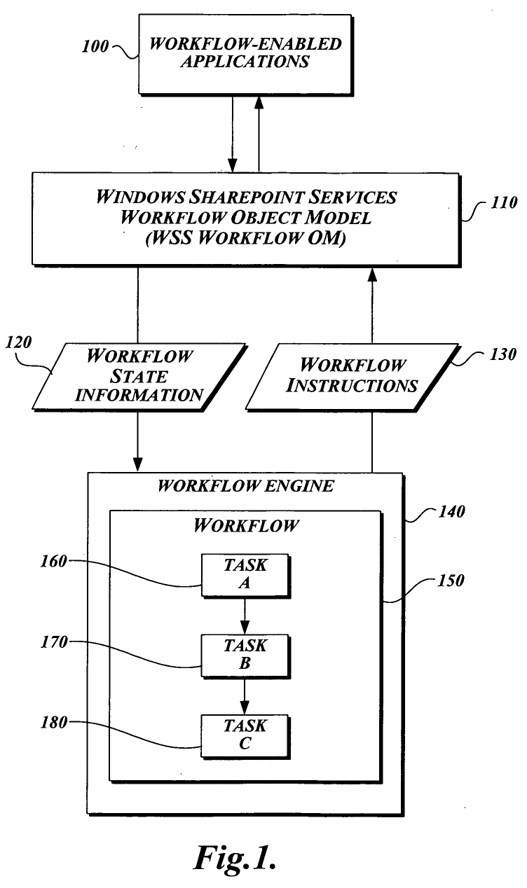

FIG. 1 is a block diagram showing how workflow-enabled applications 100 use the WSS Workflow OM 110 to exchange data with an exemplary workflow 150 executed by a workflow engine 140 that is operating as a Windows SharePoint service. Workflow-enabled applications 100 interact directly with WSS through the API provided by WSS Workflow OM 110. Workflow state information 120 passes from workflow-enabled applications 100 through WSS Workflow OM 110 to an exemplary workflow engine 140. Workflow state information is then passed by the workflow engine 140 to an exemplary workflow 150. The exemplary workflow 150 contains three exemplary workflow tasks designated, Task A 160, Task B 170, and Task C 180. In the illustrated example, the workflow tasks in the workflow 150 are arranged in a serial fashion, i.e., the workflow tasks are scheduled to be executed in a serial fashion. A workflow may contain a single workflow task or a plurality of workflow tasks. Workflow tasks may also be executed in parallel. The number and execution order of the workflow tasks in the illustrated workflow 150 should be construed as exemplary and not limiting. The workflow engine 140 passes workflow instructions 130 from workflow 150 through the WSS Workflow OM 110 to the workflow-enabled applications 100.

The exemplary workflow tasks illustrated in FIG. 1, namely Task A 160, Task B 170, and Task C 180 provide a variety of workflow capabilities, including, but not limited to: providing forms data to support user interfaces to enable users (participants) to interact with workflows within applications; roll back for uncompleted actions; assigning tasks to functions to groups of participants; and enabling participants to claim tasks. The aforementioned capabilities are supported by functions available in workflow tasks. Those skilled in the art will appreciate that workflow tasks may be implemented as software objects, i.e., objects, that are instances of a class of software objects. The class of software objects may be named “WorkflowTask” or “ToDo,” for example. A class encapsulates, i.e., contains, the functions of the class. Those skilled in the art will appreciate that a “function” may also be referred to as a “method.” A class may be “derived” from another class and thereby “inherit” functions contained in the class from which the class was derived. For example, if a WorkflowTask class is derived from the Task class, the WorkflowTask class inherits functions from the Task class whereby the WorkflowTask class contains functions also contained in the Task class.

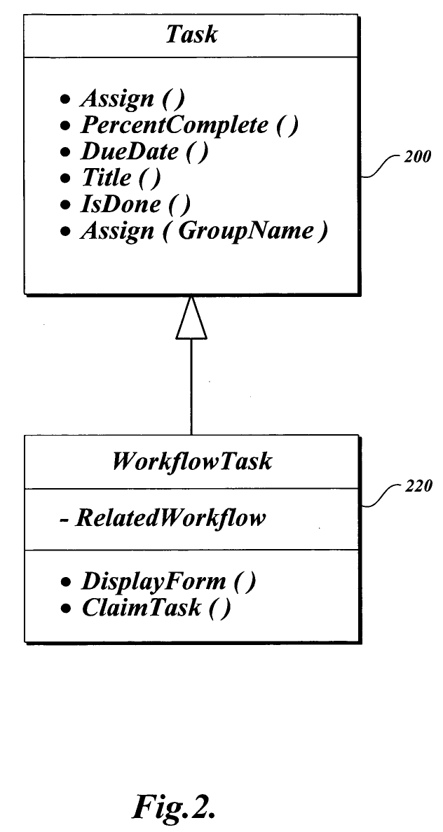

FIG. 2 is an exemplary class diagram showing a Task class 200 and a WorkflowTask class 220. The upward pointing arrow connecting the two classes indicates that the WorkflowTask class 220 is derived from the Task class 200 and thus inherits functions from the Task class 200. The Task class 200 contains general purpose functions exemplary illustrated as comprising Assign, PercentComplete, DueDate, Title, IsDone, and Assign(GroupName). The class WorkflowTask 220 contains functions exemplary illustrated as comprising DisplayForm and ClaimTask in addition to the aforementioned functions contained in the Task class 200. The class WorkflowTask 220 also contains the RelatedWorkflow property. The Assign function assigns a participant to a task. The PercentComplete function returns the percentage of completion of a task. The DueDate function returns the date that a task is due for completion. The IsDone function returns true if a task is complete. The Assign(GroupName) function is a version of the Assign( ) function that assigns a participant group named GroupName to a task. Note that a WorkflowTask object is a Task object and therefore includes the Assign, PercentComplete, DueDate, Title, IsDone, and Assign(GroupName) functions. As noted above, a WorkflowTask object also contains the functions DisplayForm and ClaimTask functions and RelatedWorkflow property. The DisplayForm function returns a form from a plurality of forms associated with a workflow task. The ClaimTask function enables a user to claim the workflow task associated with a document. The property RelatedWorkflow is set when a task is created. The collaborative application, e.g., SharePoint reads the RelatedWorkflow property to determine which workflow to inform when the task's state has changed.

The workflow capability of providing forms data to support user interfaces to enable users (participants) to interact with workflows within applications is supported by the DisplayForm function and RelatedWorkflow property. A workflow provides forms data to a workflow-enabled application. The workflow-enabled application generates and presents in a graphical user interface (GUI) a form or a form set that conforms to the specific GUI standards of the workflow-enabled application. Providing forms data, as opposed to providing forms, reduces the quantity and scope of form programming details the workflow must implement and often reduces the amount of data sent from the workflow to the workflow-enabled application. Reducing the amount of data sent may also improve transmission speed. It is also possible for a workflow to generate complete but perhaps less adaptable forms that are sent to, and presented by, work-flow enabled applications.

The roll back workflow capability enables a workflow to roll back a task, i.e., restore a task to a previous stable state, in circumstances that may keep a workflow from being completed correctly, e.g., unauthorized activities. For example, roll back may be used to compare who attempted to complete a task to the task assignee and determine from the comparison if the task completion is authorized. If the task completion is authorized, the task is modified, i.e., set to a “completed” state. If the task completion is unauthorized, the task is reset to the state before the task completion was attempted. The roll back workflow capability is implementation dependent. Implementations of the roll back workflow capability use functions and/or properties of workflow tasks and workflow instances to determine if a task change or completion is authorized. An exemplary implementation of roll back uses the PercentComplete, DueDate, and IsDone functions and RelatedWorkflow property. A roll back implementation may also communicate with external systems in order to make an authorization decision. For example, an exemplary expense report approval workflow compares the approval limit of a user to the approval limit of an expense report in order to determine if the user is allowed to complete a workflow task. The exemplary expense report may communicate with an external system to get the user's approval limit.

The “group assignment” workflow capability enables a workflow to assign a task to a group of participants. This allows a task to be completed by a participant in the assigned group. One advantage of this capability is that if a participant assigned to a task is unavailable, another participant in the group can claim the task. The task claiming workflow capability is supported directly by the ClaimTask function and indirectly by the Assign(GroupName) function.

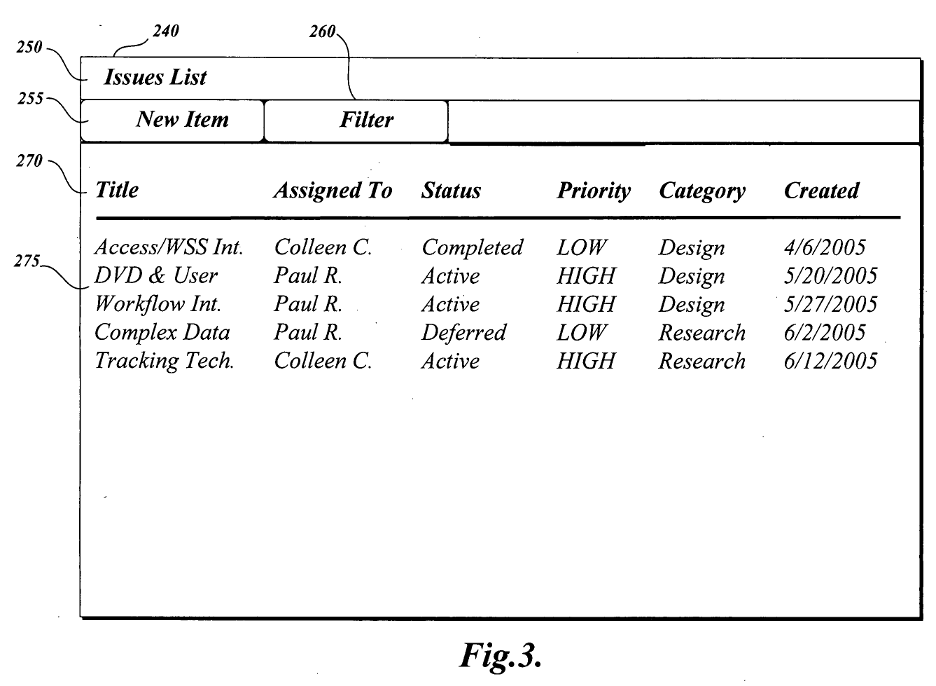

Information about workflow tasks that is returned by the aforementioned functions may be presented in user interfaces such as the exemplary user interfaces illustrated in FIGS. 3 through 6. The type of user interface illustrated in FIGS. 3 through 6 is referred to as a “window,” i.e., a bounded portion of a computer display dedicated to an application or feature of an application. FIG. 3 illustrates an exemplary workflow task window 240 that presents an exemplary list of workflow tasks associated with a exemplary workflow. In the exemplary workflow task window 240, workflow tasks are described as “issues.” As a result, the title bar 250 of the workflow task window 240 displays the title “Issues List.” Below the title bar 250 is a toolbar containing three exemplary buttons, each labeled with the name of the action the button invokes when clicked, namely “New Item” 255; and “Filter” 260. Below the toolbar is a table of data about workflow tasks, i.e., issues. The table comprises a five column name header 270 and a data block 275 of five rows of data. The column name header 270 contains the names “Title,” “Assigned To,” “Status,” “Priority,” “Category,” and “Created.” The first row of data is “Access/WSS Int.,” “Colleen C.,” “Completed,” “LOW,” “Design,” and “4/6/2005.” The second row of data is “DVD & User,” “Paul R.,” “Active,” “HIGH,” “Design,” and “5/20/2005.” The third row of data is “Workflow Int.,” “Paul R.,” “Active,” “HIGH,” “Design,” and “5/27/2005.” The fourth row of data is “Complex Data,” “Paul R.,” “Deferred,” “LOW,” “Research,” and “6/2/2005.” The fifth row of data is “Tracking Tech.,” “Colleen C.,” “Active,” “HIGH,” “Research,” and “6/12/2005.” If the “New Item” button 255 is clicked, a user interface component that may be a window or dialog box or the like is presented enabling the creation of a new item in the list. If the “Filter” button 260 is clicked, a user interface component that may be a window or dialog box or the like is presented enabling the creation of a filter to show only certain items in the list. The window described above and illustrated in FIG. 3 may be used to view and manipulate workflow tasks associated with a project managed by a workflow. The names, titles, and workflow task data described above and illustrated in FIG. 3 should be construed as exemplary and not limiting.

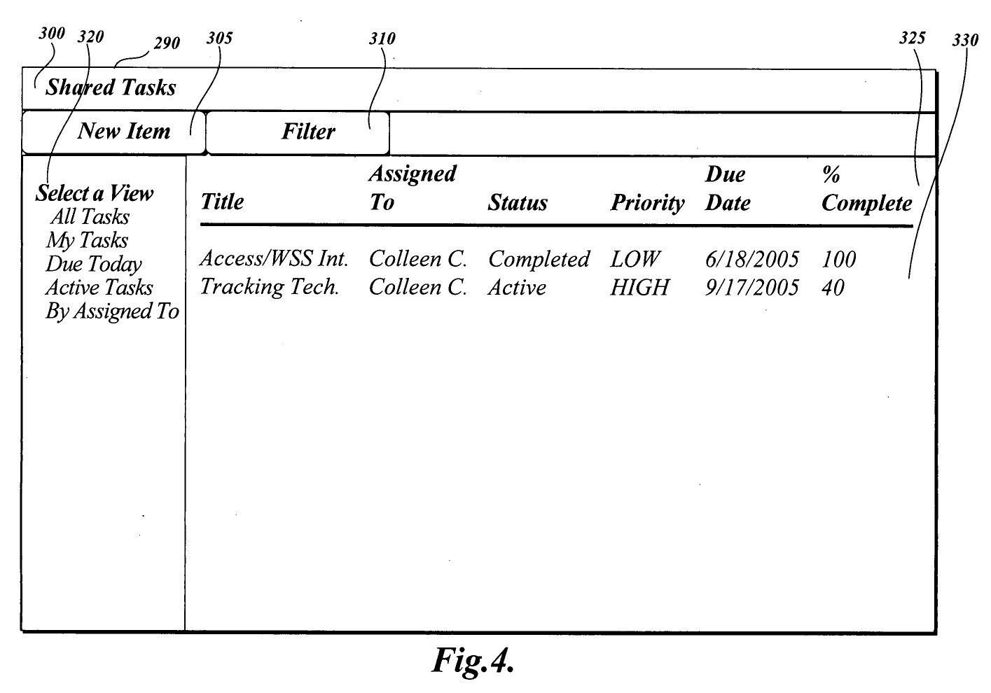

A participant in a project may view and manipulate workflow tasks using an exemplary Shared Tasks window 290 illustrated in FIG. 4 and described below. The title bar 300 of the Shared Tasks window 290 displays the title “Shared Tasks.” “Shared Tasks” are workflow tasks assigned to a group of participants. Thus, the Shared Tasks window 290 displays workflow tasks a participant shares with other participants included in a group of participants. FIG. 4 is an exemplary Shared Tasks window that supports the workflow capability of assigning tasks to groups of participants and enabling participants in a group to claim tasks assigned to the group. In essence, FIG. 4 displays subsets of the workflow tasks (issues) listed in FIG. 3 and described above.

Below the title bar 300 is a toolbar containing three exemplary buttons titled: “New Item” 305; and “Filter” 310. While buttons similar to the “New Item” 305 and “Filter” 310 buttons shown in FIG. 4 appear in FIG. 3, the actions invoked by the buttons shown in FIG. 4 may, or may not, be similar.

On the left side of the Shared Tasks window 290, below the toolbar, is a list of other possible views of workflow tasks titled “Select a View” 320. The views available in the “Select a View” list 320 are titled: “All Tasks,” “My Tasks,” “Due Today,” “Active Tasks,” and “By Assigned To.” A view is selected by clicking on a type of view in the list 320. For instance, if “My Tasks” is clicked, a view showing only the shared (workflow) tasks of the participant is presented. On the right side of the window below the toolbar is a table containing data about a subset of workflow tasks listed in data block 275. The table comprises a column name header 325 and a data block 330 comprising two rows of data. The column name header 325 contains the names “Title,” “Assigned To,” “Status,” “Priority,” “Due Date,” and “% Complete.” The first row of data is “Access/WSS Int.,” “Colleen C.,” “Completed,” “LOW,” “6/18/2005,” and “100.” The second row of data is “Tracking Tech.,” “Colleen C.,” “Active,” “HIGH,” “9/17/2005,” and “40.” The first and second names relate to the first and fifth rows of FIG. 3. Thus, FIG. 4 depicts a subset of FIG. 3, albeit in somewhat different column form. As with FIG. 3, the names, titles, and workflow task data described above and illustrated in FIG. 4 should be construed as exemplary and not limiting.

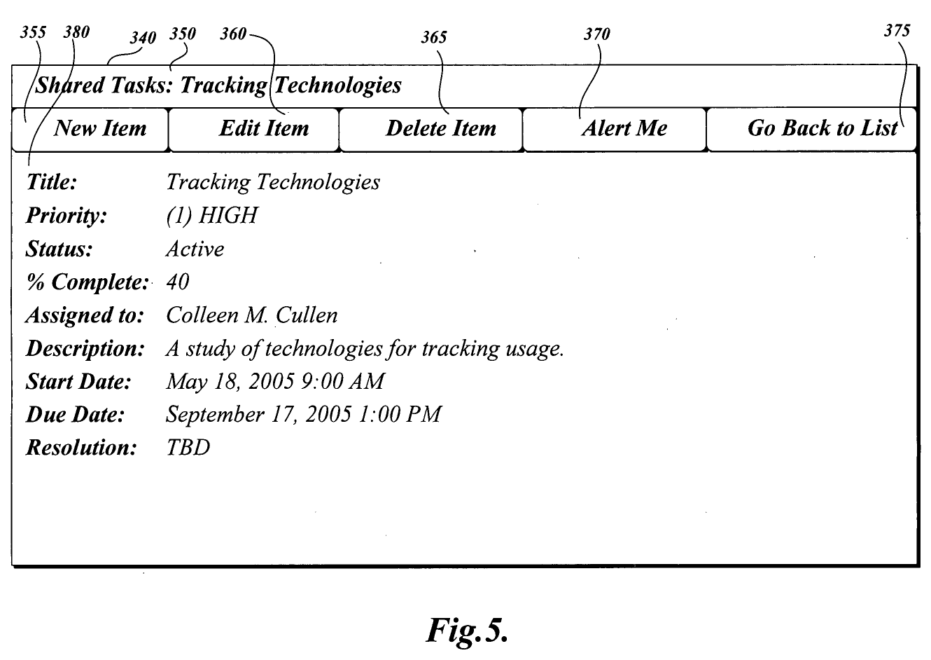

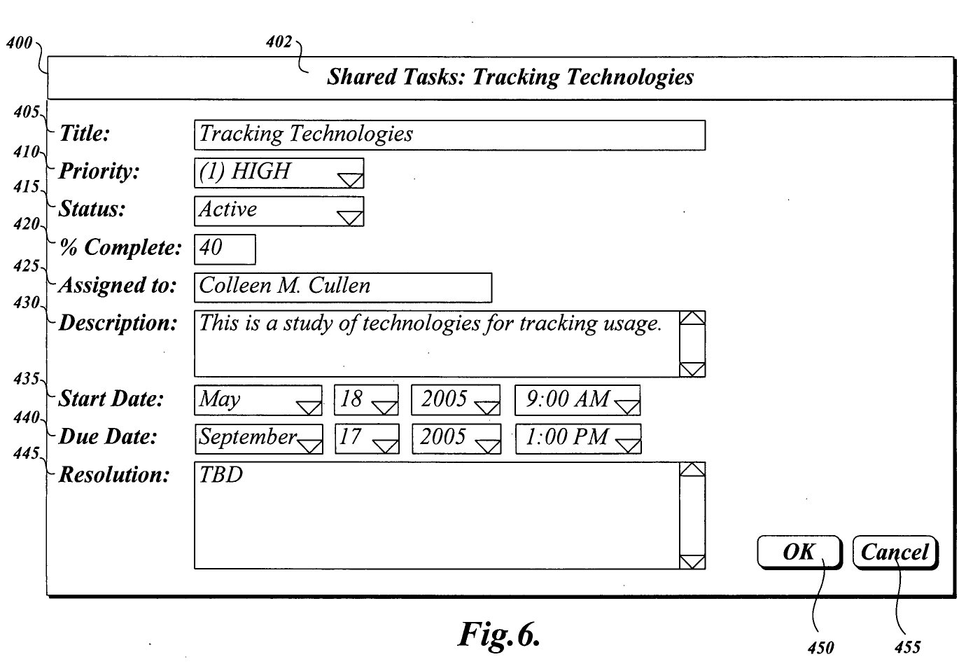

FIG. 5 illustrates an exemplary window 340 that provides a view of the details of a workflow task selected from either the set of workflow tasks 275 shown in FIG. 3 or the subset of workflow tasks 330 shown in FIG. 4. The title bar 350 of the exemplary detail window 340 displays the title “Shared Tasks: Tracking Technologies.” Note that “Tracking Technologies” is the title of the workflow task listed in the last row of FIG. 3 and the second row of the data block 330 of FIG. 4. Thus, the details shown in the detail window 340 pertain to the “Tracking Technologies” workflow task. Below the title bar 350 is a toolbar containing five exemplary buttons: “New Item” 355, “Edit Item” 360, “Delete Item” 365, “Alert Me” 370, and “Go Back to List” 375. Below the toolbar is a data view 380 for the workflow task, e.g., “Tracking Technologies.” The data is presented as pairs of field names and data in an uneditable fields. That is, the detail window 340 is a read-only window, i.e., data displayed in the fields cannot be edited in the window. The name/data field pairs are: “Title: Tracking Technologies;” “Priority: (1) HIGH;” “Status: Active;” “% Complete: 40;” “Assigned to: Colleen M. Cullen;” “Description: A study of technologies for tracking usage.;” “Start Date: May 18, 2005 9:00 AM;” “Due Date: Sep. 17, 2005 1:00 PM;” and “Resolution: TBD.” When button “New Item” 355 is clicked, a window similar to the window shown in FIG. 6 but devoid of data is presented allowing the entry of new data. The entering of data is illustrated in FIG. 6 and discussed below. When button “Edit Item” 360 is clicked, a window similar to the window shown in FIG. 6 is presented containing editable data pertaining to the selected workflow task. When button “Delete Item” 365 is clicked, a selected workflow task, e.g., “Tracking Technologies” is deleted, the “Issues List” window in FIG. 3 is presented, and the window shown in FIG. 5 is closed. When button “Alert Me” 370 is clicked, the workflow is informed that the user should be alerted when an action is taken on the task. When button “Go Back to List” 375 is clicked, the “Issues List” window in FIG. 3 is presented, and the window shown in FIG. 5 is closed. As with FIGS. 3 and 4, the names, titles, and workflow task data described above and illustrated in FIG. 5 should be construed as exemplary and not limiting.

FIG. 6 is an exemplary edit window 400 used to edit the details of a workflow task. The title bar 402 of the exemplary edit window 400 displays the title “Shared Tasks: Tracking Technologies.” Note that “Tracking Technologies” is the title of the last row of FIG. 3 and the second workflow task listed in the data block 330 shown in FIG. 4. Thus, the details shown in the edit window 400 pertain to the second workflow task. In the lower right corner of the window are an “OK” button 450 and a “Cancel” button 455. The data is presented as pairs of field names and data in an editable fields, i.e., data may be changed using the window. The name/data field pairs correspond to the name/data field pairs illustrated in FIG. 5 and described above, namely: “Title:”, “Tracking Technologies” 405; “Priority:”, “(1) HIGH” 410; “Status:”, “Active” 415; “% Complete:”, 40″ 420; “Assigned to:”, “Colleen M. Cullen” 425; “Description:”, “This is a study of technologies for tracking usage.” 430; “Start Date:”, “May 18, 2005 9:00 AM” 435; “Due Date:”, “Sep. 17, 2005 1:00 PM” 440; and “Resolution:”, “TBD” 445. Note that the “Priority:” 410, “Status:” 415, “Description:” 430, “Start Date:” 435, and “Due Date:” 440 fields provide combo boxes. Those skilled in the art will appreciate that combo boxes are a combination of a menu and a text field allowing a fixed value to be selected from a list of fixed values or values to be entered by typing in the field directly. Note also that the “Description” field 430 and the “Resolution:” field 445 are scrollable fields enabling long, multiline entries. As with FIGS. 3-5, The names, titles, and workflow task data described above and illustrated in FIG. 6 should be construed as exemplary and not limiting.

The windows illustrated in FIGS. 3 through 6 may be invoked using a workflow application or from within a workflow-enabled application program. Microsoft® Word, a word processing application program, and Microsoft® Outlook®, an e-mail application program, are examples of application programs that may be workflow-enabled. A workflow-enabled application program contains computer instructions that enable the application to communicate with a workflow engine 140 through a programming interface, such as WS S Workflow OM 110, to take advantage of the functions in classes, such as the Task and WorkflowTask classes illustrated in FIG. 2 and described above.

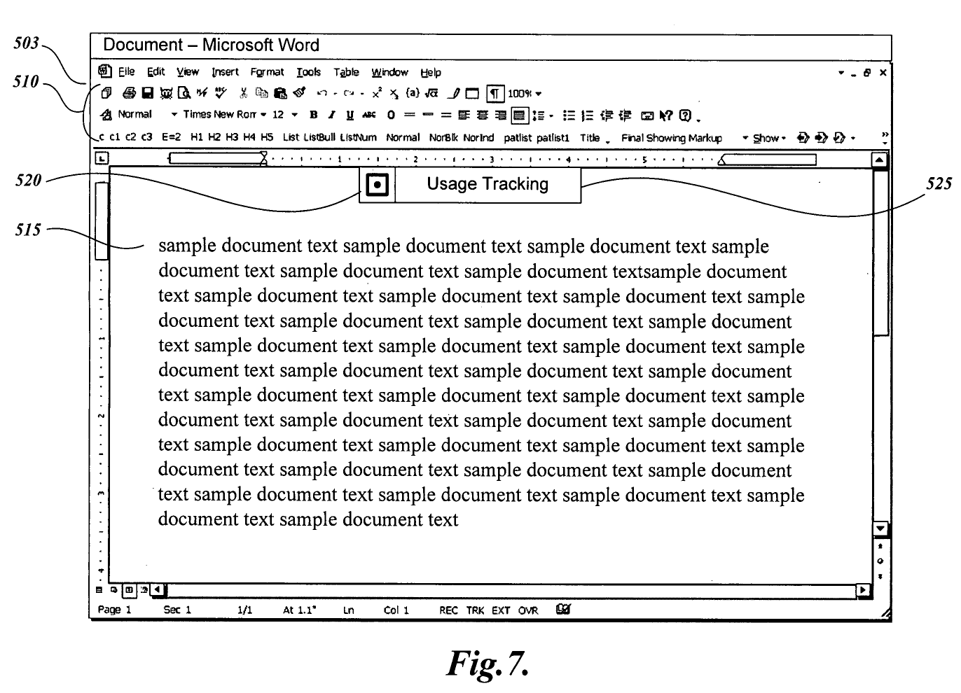

FIG. 7 illustrates an exemplary document in an exemplary workflow-enabled implementation of Microsoft Word that may be used to invoke windows such as those illustrated in FIGS. 3 through 6. The exemplary title bar of the window in FIG. 7 displays the exemplary title “Document—Microsoft Word.” As in normal, non-workflow-enabled implementations of Microsoft Word, there is a menu bar 503 below the title bar of the window. The menu bar 503 contains a series of conventional menus, namely: “File,” “Edit,” “View,” “Insert,” “Format,” “Tools,” “Table,” “Window,” and “Help.” Below the menu bar 503 are three tool bars 510. The menu bar 503, the menus the menu bar 503 contains, the three tool bars 510, and the icons in the three tool bars 510 should be construed as exemplary and not limiting. Other implementations may or may not include the menu bar 503 and three tool bars 510 and may or may not include other menu bars, menus, tool bars, and icons.

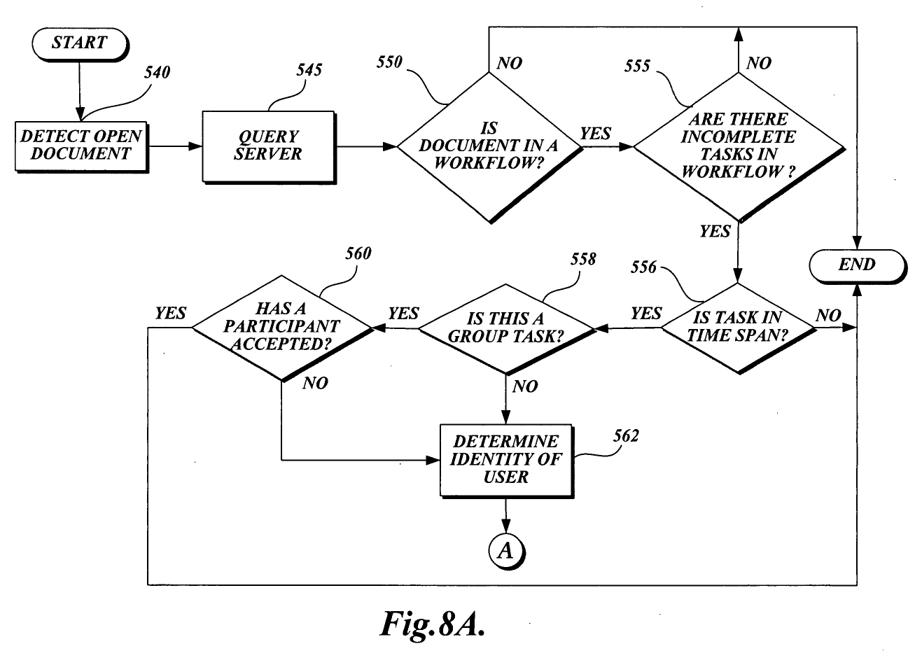

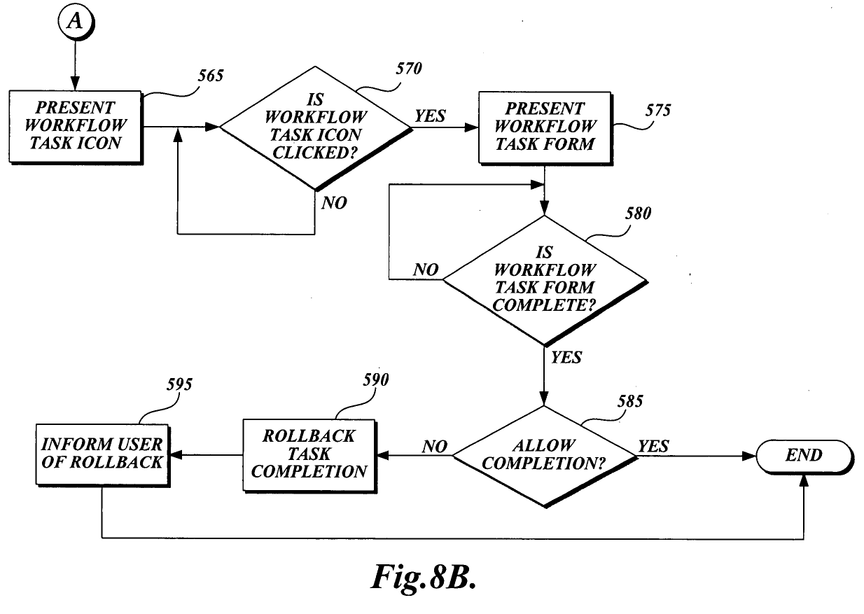

A document is shown in a scrollable pane 515 below the three tool bars 510. The document and document contents should be construed as exemplary and not limiting. At the top of the scrollable pane 515 is an icon 520 and name field 525 containing the name “Usage Tracking.” The icon 520 and the name field 525 represent an incomplete workflow task associated with the document. If an opened document is managed by a workflow and if there are active workflow tasks assigned to the user who opened the document, the icon 520 and name field 525 are displayed by the workflow-enabled application. An exemplary process of detecting the aforementioned attributes is illustrated in FIGS. 8A and 8B and described below. When the icon 520 is clicked, a window similar to the window illustrated in FIG. 5 is displayed. Thus, the icon forms a link to the related window.

An important advantage of using workflows is that workflows inform workflow participants when activities need to be performed on workflow tasks. For example, a workflow may inform a participant of an activity to be performed on a workflow task by providing access to workflow forms within a workflow-enabled application when a document associated with a workflow is opened by a participant. FIG. 8A and 8B comprise a flow diagram illustrating an exemplary process by which a participant may open a document associated with a workflow, in an exemplary workflow-enabled application (Microsoft Word), and be informed by the workflow that activities need to be performed on a workflow task. The workflow-enabled application provides direct access to the workflow forms needed to interact with a workflow on a workflow task.

In FIG. 8A, at block 540, the workflow-enabled application, e.g., Microsoft® Word, detects an open document. At block 545, the workflow-enabled application queries the server (the SharePoint server in the exemplary case of WSS) to find out if the document is included in a workflow. At block 550, if the document is not included in a workflow, the process ends. If the document is included in a workflow, the flow proceeds to block 555 where the workflow is checked for active, incomplete tasks. If, at block 555, there are no active, incomplete tasks in the workflow, the process ends. If there are active, incomplete tasks in the workflow, the flow proceeds to block 556.

At block 556, it is determined if the task is within the time span set for the task, i.e., a task time span. A task time span prescribes when a task begins and ends. For example, a document cannot be approved until a draft of the document is written. Thus, preferably, the time span for the approval task of the document should begin after the time scheduled for the completion of a draft of the document. The same document may need to be approved before a certain date in order to be useful. Thus, preferably, the time span for the approval task of the document should end before the useful time of the document ends. If the time at which the task is examined is before or after the time span of the task, the task is not within the time span of the task. If the task is not within the time span of the task, the workflow engine rolls back the workflow task and, preferably, ends the process. There may be other reasons that dictate the beginning and ending of a task time span. Thus, setting a task time span according to when a document is available and useful should be construed as exemplary and not limiting. There may be other circumstances besides, or in addition to, time span circumstances that require roll back. Thus, time span circumstances requiring roll back should be construed as exemplary and not limiting. If the task is within the time span set for completion of the task, the control flows to block 558 to determine if the task is a group task, i.e., the task is assigned to a group using the Assign(GroupName) function. If the task is a group task, the control flows to block 560. If the task is not a group task, i.e., not assigned to a group, the control flows block 562.

At block 560, the workflow engine 140 determines if a group participant has already accepted the task. Acceptance may be accomplished in various ways, such as another participant sending an acceptance message, automatically sending an acceptance message when a participant clicks on a usage tracking icon 520 (FIG. 7), etc. If a group participant has already accepted the task, the process ends. At block 562, the identity of the application's user, i.e., the user that opened the document (block 540), is determined. This determination may be based on a log-on identifier that identifies the person that logged on to the computer that opened the document, for example.

Moving to block 565 in FIG. 8B, the workflow engine informs the application to present a workflow task icon, e.g., icon 520 in FIG. 7. The application displays the icon. At block 570, the application idles and waits for the workflow task icon to be clicked. If the workflow task icon is clicked, the control flow proceeds to block 575 where the application presents a workflow task form. More specifically, the workflow sends form data to the word processing application program, i.e., Microsoft Word, that causes the word processing program to present a form to the user (participant) whose opening of a document started the process. At block 580, the application idles and waits for the workflow task form to be completed. If, at block 580, the workflow task is complete, the control flows to block 585. At block 585, one or more final checks are done to ensure that the workflow task should be saved. The final checks are implementation dependent. For example, a check is done to be sure the user has SharePoint permissions to save the task. If the final checks succeed, the task is saved and the process ends. Preferably, if any of the final checks fail, control flows to block 590 where the task is rolled back. At block 595, the user is informed of the rollback and preferably the reason for the roll back and then, the process ends.

If the task is a group task, a task acceptance message may be sent when the user clicks on the workflow task icon, or when the workflow task form is complete. Alternatively, a separately generated task acceptance message may be sent when the user clicks on a task acceptance icon, for example.

In addition to avoiding the need for a user to switch from one application to another in order to complete a workflow task, a workflow-enabler application of the type illustrated in functional flow form in FIGS. 8A and 8B provides roll back for incomplete workflow tasks that fall outside of their completion time period by preventing a task icon and/or a name field to be displayed. This result is accomplished by the is task in time span test conducted at block 556. Likewise for completed tasks. Such tasks do not create a task icon and/or name field display as a result of the test conducted at block 555. In addition, a workflow-enabled application of the type illustrated in functional flow form in FIGS. 8A and 8B allows one member of a group to accept a task in a manner that prevents duplication of effort. It is to be understood, of course, that the sequence of functions illustrated in FIGS. 8A and 8B is exemplary and should not be construed as limiting, since the various described functions could be performed in a different order.

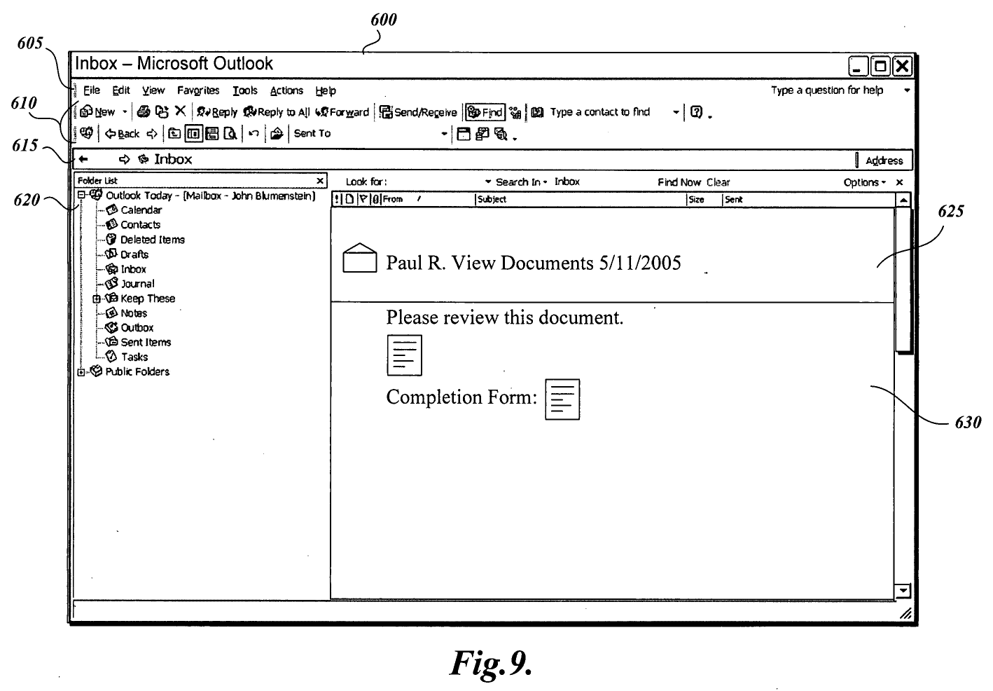

An example of an e-mail application program that can be workflow-enabled is Microsoft Outlook. FIG. 9 illustrates an exemplary e-mail opened in an exemplary implementation of Microsoft Outlook that displays exemplary icons for workflow tasks. The title in the title bar 600 of the Microsoft Outlook window is “Inbox—Microsoft Outlook.” Below the title bar 600 is a menu bar 605 containing the menus “File,” “Edit,” “View,” “Favorites,” “Tools,” “Actions,” and “Help.” Below the menu bar 605 are two icon bars 610. Below the icon bars 610 is a title bar 615 referring to the pane below the title bar and displaying the titles “Inbox” and “Address.” Below the title bar 615 on the left side of the pane is a hierarchical, i.e., tree, view 620 of directories and files available in Outlook named “Folder List.” The directory, i.e., folder, at the top of the tree is named “Outlook Today—(Mailbox—John Blumenstein).” Below the top folder are elements named “Calendar,” “Contacts,” “Deleted Items,” “Drafts,” “Inbox,” “Journal,” “Keep These,” “Notes,” “Outbox,” “Sent Items,” and “Tasks.” Below the elements is another folder named “Public Folders.” To the right of the tree view 620 are two sections. The top right section 625 is a document view containing an “open envelope” icon named “Paul R. View Documents 5/11/2005.” The open envelope icon indicates that there is an e-mail document opened in the bottom right section 630. The bottom right section 630 contains a “document” icon named “Please review this document” and a “form icon” name “Completion Form:”. A workflow participant with an assigned workflow task may receive an e-mail such as the e-mail represented by the open envelope icon when work is required by the workflow task. When the e-mail is opened, icons such as the illustrated document and form icons are displayed. The document to be reviewed is opened for review by clicking on the document icon. The completion form for the workflow task associated with the document is opened by clicking on the form icon. The Outlook application, icons, names, and documents should be construed as exemplary and not limiting.

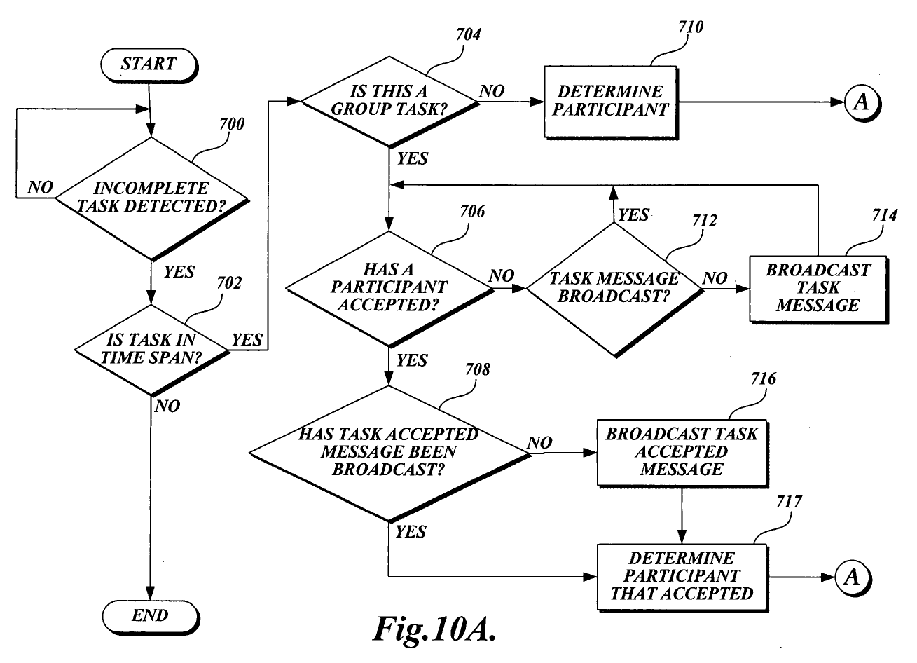

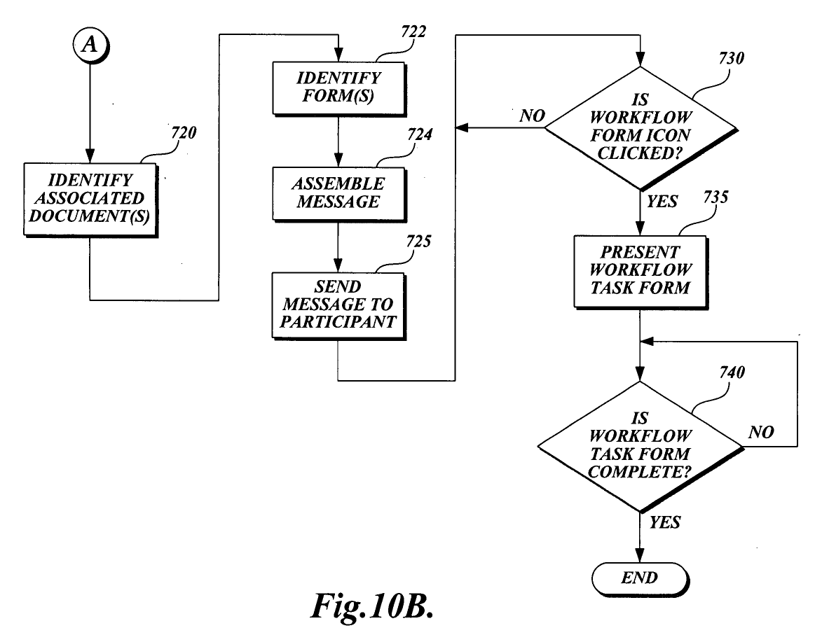

Workflow-enabled e-mail applications such as Microsoft Outlook, described above and illustrated in FIG. 9, provide another way for workflows to inform workflow participants when activities need to be performed on workflow tasks. FIGS. 10A and 10B comprise a flow diagram illustrating an exemplary process by which a participant may be informed, via an exemplary e-mail message from a workflow, about workflow tasks that need to be performed. A message from the workflow to the e-mail application provides direct access to the workflow forms needed to respond to the workflow task.

In FIG. 10A, at block 700, the workflow engine 140 examines the workflows being managed and executed by the workflow engine 140 to determine if there are any incomplete tasks. If no active, incomplete workflow tasks are detected, the control flow remains in a wait loop around block 700. If an active, incomplete task is detected, the flow proceeds to block 702. At block 702, a test is made to determine if the task is within the task's time span. If the task is not within the task's time span, the workflow engine rolls back the task and ends the process. If the task is within the task's time span, the control flows to block 704. At block 704, a test is made to determine if the task is a group task. If the task is not a group task, i.e., not assigned to a group, the control flows to block 710, where the identity of the participant assigned to the task is determined. Thereafter, flow proceeds to block 720 of FIG. 10B (described below).

If the task is a group task, i.e., the task is assigned to a group, e.g., using the Assign(GroupName) function, the control flows to block 706. At block 706, it is determined if a group participant has accepted the task, where a test is made to determine if the task has been accepted by one of the group participants. If a group participant has accepted the task, the control flows to block 708. At block 708, a test is made to determine if a message has been broadcast informing the group that the task was accepted, i.e., a task accepted message has been broadcast. If a task accepted message has been broadcast, the control flows to block 717. If the task accepted message has not been broadcast, control flows to block 716 where a task accepted message is broadcast. Control then flows to block 717. At block 717, the group participant that accepted the task is determined. Then control flows to block 720 of FIG. 10B (described below).

Returning to block 706, if a group participant has not accepted the task, the control flows to block 712. At block 712, a test is made to determine if a message has been broadcast to the group informing the group of the incomplete task, i.e., a test is made to determine if a task message has been broadcast. If a task message has been broadcast, after a delay, control flows back to block 706. If a task message has not been broadcast, control flows to block 714 where the task message is broadcast. Then control flows back to block 706. There may also be other delays and checks involved depending on how a workflow is designed.

Turning to FIG. 10B, at block 720, any documents associated with the incomplete task are identified. A trip report, for example. At block 722, any forms required to accomplish the task are identified. At block 724, an e-mail message informing the participant of the activity and providing access references (i.e., links) to the affected document(s) and required form(s) is assembled. At block 725, the e-mail message is sent to the participant. When the participant opens the e-mail message, icons, such as the document and form icons illustrated in FIG. 9 and described above, are presented to the participant. As described above, clicking on the document icon or the form icon accesses the document or the form. As with the word processing application example described above, preferably clicking on the form causes form data to be downloaded for use by the e-mail program to create a suitable form in a manner well known to those skilled in the art. At block 730, if the icon to invoke the workflow form is not clicked, the control flow is directed back through block 730. If the icon to invoke the workflow form is clicked, the flow control proceeds to block 735. At block 735, the form data is used to create a workflow task form for presentation to the participant. At block 740, the workflow task form is presented until the workflow task form is completed. When the workflow task is completed, the process ends. Completion occurs when the completed form is sent to the workflow.

The exemplary processes described above and illustrated in FIGS. 7 through 10B describe one task, one activity, one document, and one form. It is to be understood that the exemplary processes may also be applied to more than one task, activity, document, and/or form. The number of tasks, activities, documents, and forms in the processes should be construed as exemplary and not limiting. The examples of workflows informing workflow participants of workflow activities, described above and illustrated in FIGS. 7 through 10B, should be construed as exemplary and not limiting. In this regard, as noted above with respect to FIGS. 8A and 8B, the various described functions shown in FIGS. 8A and 8B and 10A and 10B can be performed in other manners and sequences. Thus, the functional flow illustrated in these figures should be construed as exemplary, and not limiting. It is also to be understood that the invention should not be construed as limited to word processing and e-mail programs. It is also to be understood that some of the described functions may be performed either by a workflow server, or by a workflow enabled application, depending on a specific embodiment or implementation.

In general, although the subject matter has been described in language specific to structural features and/or methodological acts, it is to be understood that the subject matter defined in the appended claims is not necessarily limited to the specific features or acts described above. Rather, as noted, the specific features and acts described above are disclosed as example forms of implementing the claims.

The embodiments of the invention in which an exclusive property or privilege is claimed are defined as follows:

1. A method of providing workflow task capabilities comprising:
determining if an incomplete workflow task exists;
if an incomplete workflow task exists, sending forms data to a workflow-enabled application program; and
in response to the receipt of forms data, said workflow-enabled application program presenting a workflow task form to the user of the workflow-enabled application program.

2. The method of claim 1 wherein determining if an incomplete workflow task exists occurs when a document is opened by the user of said workflow-enabled application program.

3. The method of claim 2, wherein determining if an incomplete workflow task exists comprises:
querying a server to determine if the opened document is in a workflow; and
if the document is in a workflow, determining if an incomplete workflow task exists.

4. The method of claim 3, wherein, prior to sending forms data to the workflow-enabled application program, determining if the user of the workflow-enabled application program is assigned to the incomplete workflow task.

5. The method of claim 1, including:
determining the period set for execution of the incomplete workflow task;
determining if the period for execution of the incomplete workflow task has begun; determining if the period for execution of the incomplete workflow task has ended; and
sending said forms data to said workflow-enabled application program only if said period for execution of the incomplete workflow task has begun and not ended.

6. The method of claim 1, including:
determining if the incomplete workflow task is assigned to a group;
if the incomplete workflow task is assigned to a group, determining if a participant of the group has accepted the incomplete workflow task;
if the incomplete workflow task is not assigned to a group, or if the incomplete workflow task has been assigned to a group, but not accepted by a participant of the group, prior to sending forms data to the workflow-enabled application program, determining if the user of the workflow-enabled application program is a participant of the group.

7. The method of claim 1, wherein, prior to sending forms data to said workflow-enabled application program:
determining the identity of any documents associated with said incomplete workflow task;
determining the identity of any forms associated with said incomplete workflow task; and
assembling a message that includes any identified documents and forms data associated with any identified forms.

8. The method of claim 1, including:
determining if the incomplete workflow task is assigned to a group;
if the incomplete workflow task is assigned to a group, determining if a participant of the group has accepted the incomplete workflow task;
if a participant of the group has not accepted the incomplete workflow task, broadcasting a message regarding the incomplete workflow task to the participants of the group;
if a participant of the group has accepted the incomplete workflow task, determining if a task acceptance message has been broadcast; and
if a task acceptance message has not been broadcast, broadcasting a task acceptance message.

9. An application program stored in a computer-readable medium including computer-executable instructions that, when executed, provide workflow task capabilities to the application program, said computer executable instructions:
determining if an incomplete workflow task exists;
if an incomplete workflow task exists, sending forms data to said application program; and
in response to the receipt of forms data, said application program presenting a workflow task form to the user of the application program.

10. The application program claimed in claim 9, wherein determining if an incomplete workflow task exists occurs when a document is opened by the user of said workflow-enabled application program.

11. The application program claimed in claim 10, wherein determining if an incomplete workflow task exists comprises the computer executable instructions:
querying a server to determine if the opened document is in a workflow; and
if the document is in a workflow, determining if an incomplete workflow task exists.

12. The application program claimed in claim 9, wherein, prior to sending forms data to the application program, the computer-executable instructions determine if the user of the application program is assigned to the incomplete workflow task.

13. The application program claimed in claim 9, wherein the application program is a word processing program.

14. The application program claimed in claim 9, wherein the application program is an e-mail program.

15. The application program claimed in claim 9, wherein said computer-executable instructions also:
determine the period set for execution of the incomplete workflow task;
determine if the period for execution of the incomplete workflow task has begun;
determine if the period for execution of the incomplete workflow task has ended; and
send said forms data to said application program only if said period for completion of the incomplete workflow task has begun and not ended.

16. The application program claimed in claim 9, wherein said computer-executable instructions also:
determine if the incomplete workflow task is assigned to a group;
if the incomplete workflow task is assigned to a group, determine if a participant of the group has accepted the incomplete workflow task;
if the incomplete workflow task is not assigned to a group, or if the incomplete workflow task has been assigned to a group, but not accepted by a participant of the group, prior to sending forms data to the application program, determine if the user of the application program is a participant of the group.

17. The application program claimed in claim 16, wherein the application program is a word processing program.

18. The application program claimed in claim 9, wherein, prior to sending forms data to said workflow-enabled application program, said computer executable instructions:
determine the identity of any documents associated with said incomplete workflow task;
determine the identity of any forms associated with said incomplete workflow task; and
assemble a message that includes any identified documents and forms data associated with any identified forms.

19. The application program claimed in claim 9, wherein said computer-executable instructions also:
determine if the incomplete workflow task is assigned to a group;
if the incomplete workflow task is assigned to a group, determine if a participant of the group has accepted the incomplete workflow task;
if a participant of the group has not accepted the incomplete workflow task, broadcast a message regarding the incomplete workflow task to the participants of the group;
if a participant of the group has accepted the incomplete workflow task, determine if a task acceptance message has been broadcast; and
if a task acceptance message has not been broadcast, broadcast a task acceptance message.

20. The application program claimed in claim 19, wherein the application program is an e-mail program.
